(19) United States
(12) Patent Application Publication
(10) Pub. No.: US 2026/0146337 A1
(43) Pub. Date: May 28, 2026

(54) COATING COMPOSITION AND PROCESS FOR APPLYING SAME TO METAL SUBSTRATES

(71) Applicant: CIA. INDUSTRIAL H. CARLOS SCHNEIDER, JOINVILLE (BR)

(72) Inventor: Marcelo DA SILVA GOMES, SANTO ANDRE (BR)

(21) Appl. No.: 19/122,539

(22) PCT Filed: Sep. 15, 2023
(86) PCT No.: PCT/BR2023/050308

§ 371 Date: Apr. 18, 2025

(30) Foreign Application Priority Data
Oct. 31, 2022 (BR) 1020220220697

(51) Int. Cl. C23F 11/18; C09D 1/00; C09D 5/02; C09D 5/10; C09D 7/20; C09D 7/40; C09D 7/61; C09D 123/30; C09D 127/18

(52) U.S. Cl. CPC C23F 11/187; C09D 1/00; C09D 5/022; C09D 5/028; C09D 5/10; C09D 7/20; C09D 7/61; C09D 7/67; C09D 7/68; C09D 7/69; C09D 123/30; C09D 127/18

(57) ABSTRACT

The present patent of invention is related to a composition of a coating configured by at least two layers, being a base layer and a nano composite top layer of an aqueous coating containing silicon nanoparticles and stainless steel nano and micro particles, preferably class 316L steel, to enhance protection against corrosion and the respective application process of said coating on metallic substrates.

The present invention belongs to the field of coating compositions, more specifically, it is related to a composition of a coating configured by at least two layers, whereby one is a base layer and a nanocomposite layer containing silicon nanoparticles and stainless steel nano and microparticles to enhance protection against corrosion and the respective application process of said coating on metallic substrates.

### HISTORY OF THE INVENTION

Metallic corrosion is the transformation of a metallic material or metal alloy through its chemical or electrochemical interaction in a specific exposure environment, which process results in the formation of corrosion products and the release of energy. Almost always, metal corrosion by electrochemical mechanism is associated with the exposure of metal in a medium with the presence of water molecules, together with oxygen gas or hydrogen ions, in a conductive medium.

The adoption of one or more forms of protection against corrosion of metals must consider technical and economic aspects. Among the technical aspects, the means of exposure is a parameter of great importance. Regarding this parameter, the use of corrosion inhibitors or the control of aggressive agents, such as SO2, H⁺ and Cl, is impractical in cases where it is desired to protect a certain metal against atmospheric corrosion and the same is true for the use of cathodic protection, leaving in these cases only the modification of the metal or the interposition of barriers as an alternative for protection against corrosion.

In some cases, the modification of the metal is perfectly applicable, citing as an example, the use of aluminum and its alloys in components such as frames, doors and windows instead of carbon steel. However, for large structures, in which mechanical strength is an important requirement, aluminum and its alloys cannot always be used, whereby stainless steels or weathering steel are potential alternative materials.

However, stainless steels are generally not economically viable and the use of weathering steels comes up against the issue of exposure conditions, since they only present satisfactory performance in atmospheres moderately contaminated with sulfur compounds and in wetting and drying conditions, in addition to the limitation of the use thereof in atmospheres with high concentration of chlorides such as for example, severe seawater.

In summary, there are many cases in which ferrous metals of carbon steel or cast iron continue to be the most suitable materials for use in structures exposed to atmospheres in general, leaving only the interposition of a barrier between this metal and the medium as a form of protection against corrosion.

For this purpose, both organic coatings (paints), as inorganic (metallic or conversion coatings such as anodizing, chromatizing) or a combination thereof are used. The choice of a corrosion protection system for ferrous metals, such as carbon steel, will depend on a number of factors, citing as one of the main ones, the degree of corrosivity of the medium.

An example is galvanizing, the process of coating one metal by another in order to protect it against corrosion and improve its appearance. It is a process of surface coating by means of electrolysis where the metal to be coated works as a cathode and the metal that will coat the part works as the anode (some inert material can also be used as an anode). The electrolyte solution must contain a salt composed of cations of the metal that is to coat the part.

Different metals can be used for coating a part, with zinc being one of the most efficient elements for coating metal parts, as it has a low cost and acts as an insulator of the plated part, preventing the item from coming into contact with air and oxidizing easily.

The coating processes in which Zinc is used are called Zinc Plating, which provides resistance to corrosion, whereby the protective layer is uniform and adherent, and time determines the thickness of the deposited layer.

Due to these characteristics, electrolytic zinc plating is widely used by industries in various market sectors and also by end consumers, for surface treatments of gates, metal structures, structural and finishing automotive parts, machinery, equipment and the most varied components.

However, the corrosion resistance of electrolytic zinc-based coatings is relatively low when compared to nobler and high-cost coatings, such as zinc alloys and organometallic (zinc flakes), which have resistances between 500 h and 1000 h in salt spray chamber tests (ASTM B-117).

On the other hand, organometallic coatings or zinc flakes or Zinc Flake have high resistance to corrosion, which is highly appreciated, since with the same layer applied in reference to electrolytic zinc, organometallic coatings have an average of 10 times more resistance to salt spray testing (ASTM B-117).

The specifications for organometallic coatings are defined in the international standards ISO 10683 and also in the European standard DIN EN 13858 which describes the requirements for zinc flake coatings for threadless elements and for other parts as well and DIN EN ISO 10683 which defines the requirements for organometallic coatings for threaded elements.

In combinations with top coats, organometallics gain special characteristics, in addition to increased corrosion resistance, they can also offer color, friction coefficient control, resistance to weathering. These coatings are supplied in liquid form and must be adjusted to the desired conditions before application, as viscosity, temperature and agitation time play an important role.

Organometallic coatings provide what is known as cathodic protection, where the less noble metal (zinc) sacrifices itself to protect the base metal (steel). The thickness of the coating is usually between 5 μm and 12 μm, and it is possible to apply thicker layers when there are special requirements, such as in cases where it is necessary to maintain the dimensions defined by ISO 965 so that screws with metric thread do not show excess or clogging of the coating and when the coefficient of friction can be adjusted accordingly.

Another existing alternative as protection against corrosion is the use of stainless steel applied to a certain group of alloys that contain chromium, at a minimum ratio of 11%, since this element offers resistance against corrosion and oxidation in the steel alloy.

This resistance to corrosion is provided by the phenomenon known as passivity, which offers resistance due to the formation of a surface protection film to the alloy by chromium oxide, even when subjected to more aggressive agents, as observed in FIG. 1. The other elements used, such as copper, nickel, molybdenum and silicon, also have favorable effects against corrosion.

The resistance of stainless steel and other metals to corrosion depends strictly on the surface conditions and, in particular, on the greater or lesser presence of the passive chromium oxide layer.

In environments where non-oxidizing acids or organic acids are present, the simple increase in the molybdenum content in the alloy increases corrosion resistance. If sulfuric acid is present, the increase in the amount of copper will offer even greater resistance to stainless steel.

On the other hand, when oxidizing acids are present, austenitic stainless steel is the most suitable, as the reduction in carbon content offers greater resistance, along with the increase in chromium content. However, when stainless steel is subjected to a temperature between 45° and 750° C., it becomes more susceptible to the precipitation of chromium carbides, and with a higher percentage of free chromium, which should bind with oxygen to form the chromium oxide layer, this layer becomes more sensitive, leaving the alloy defenseless and subject to corrosion.

An example of a state-of-the-art coating is described in document CN111944334, entitled “nanometer metal ceramic coating”, filed on May 14, 2019, which reveals a nano metallic ceramic coating, in which the inorganic nano material and the inorganic nano adhesive form a coating film by means of chemical reaction at high temperature.

Another example is document CN215662253, entitled “anti-oxidation stainless steel disc”, filed on Jul. 14, 2021 that discloses an anti-oxidation stainless steel disk comprising a substrate layer, in which the top part of the substrate layer is bonded to a first functional layer through a metal bonding agent and the first functional layer comprises a nanocomposite ceramic coating and an ultra-high strength stainless steel layer.

Another example is document CN100563799, entitled “Porous Stainless Steel-Ceramic Composite Film Preparation Technique”, filed on Feb. 29, 2008, which refers to a porous stainless steel and composite ceramic preparation technique. The layer of metal powder is added between a ceramic layer and a stainless steel base and is fired with the ceramic layer at high temperature, which can work as an adhesive.

Disadvantageously, coatings known to the state of the art, such as those described above, require complex application and processing conditions, high cost, high energy consumption, in addition to the fact that the final coating layer is thick, which increases production costs and contributes to dimensional problems and excesses or clogging of cracks and threads in parts whose dimensional control is more precise.

Further, the existing coatings have chromium VI and/or other heavy metals in their composition, responsible for the contamination of soil and rivers, as well as producing wastewater, sludge and, consequently, contributing to pollution and waste of production costs.

Thus, among the many applications, this invention aims to obtain extremely high and low-cost corrosion resistance, and can replace stainless steel fasteners for aluminum frames, facades and industrial uses, as well as enable its use in other lines, such as, for example, stainless steel fastener lines.

Aiming at a technical and affordable solution, this invention aims to apply a high-efficiency coating system against corrosion, with the purpose of offering the market an alternative solution to stainless steel and with much higher efficiency than conventional coatings, such as electrolytic zinc and zinc alloys, as well as a protective film with hardness superior to traditional zinc flake organometallic coatings.

The present invention is advantageously equipped with a double layer, i.e. a base coat layer and a nanocomposite layer with ceramic and metal particles, in which the metal particles will form a net on the surface of the base coat, which will thus protect the base of the already coated part.

Thus, the coating of this invention will help prevent the penetration of the weather without wearing or removing the nanoceramic sealant, increasing the useful life of the coating and consequently of the coated part, making the useful life of the part 50 to 100× longer in the neutral salt spray test (salt spray according to ASTM B-117 standard).

Further, with the use of the coating of this invention, it is possible to use a low thickness of the base layer with the same or higher results, further reducing costs and avoiding dimensional problems and excesses or clogging of cracks and threads in the parts, whose dimensional control is more precise.

### BRIEF DESCRIPTION OF THE FIGURES

FIG. 1 shows the action of stainless steel in protecting against corrosion, and it is possible to observe that the nanoceramic upper layer (a) containing stainless steel nano and/or micro particles reacts with oxygen (b) forming chromium oxide III layer (c), helping to protect against corrosion.

FIG. 2 shows a metal part (carbon steel screw) coated with the 5 to 8 micrometer electrolytic zinc process with two nanoceramic top layers with nano and/or micro stainless steel particles after 5.664 h of neutral salt spray test, without red corrosion (base metal corrosion).

FIG. 3 shows 410 stainless steel (ferritic) screws after 936 hours of neutral salt spray testing, whereby the uncoated samples (FIG. 3a) showed red corrosion (base metal corrosion) and the samples with coating (FIG. 3b) showed a significant decrease in red corrosion formation.

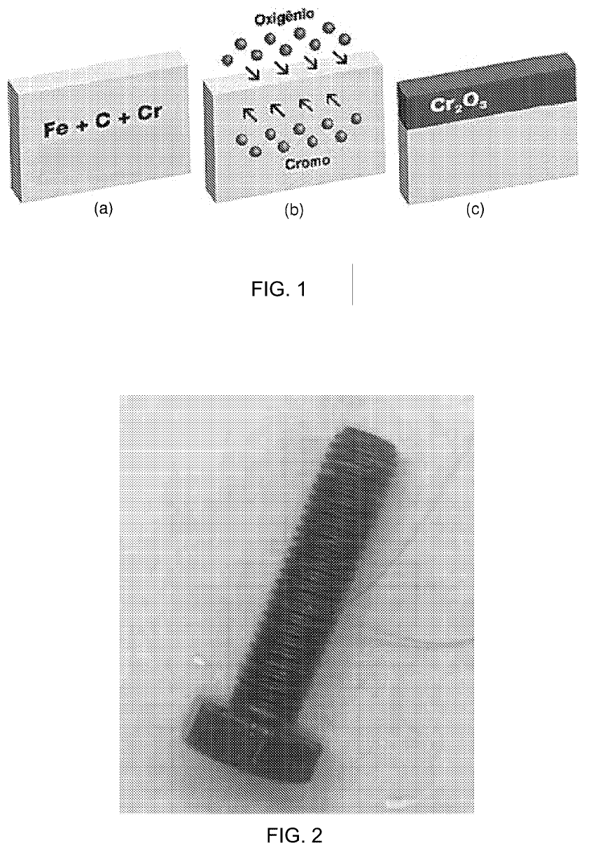

### DETAILED DESCRIPTION OF THE INVENTION

This invention discloses the composition of a double layer coating and the respective process of applying said coating to metal substrates, such as steel and iron. More specifically, the present invention aims to obtain an aqueous coating for application on metal substrates already coated with an anticorrosive base (base coat) to increase the resistance thereof to corrosion.

To this end, the present invention reveals a nanotechnology sealant containing silicon nanoparticles and powdered stainless steel alloy micro and/or nanoparticles, preferably alloys with improved properties, such as grade 316 L steel. Stainless steel is known to be highly resistant to corrosion, however its cost is often prohibitive in large-scale uses.

The anti-corrosion coatings used on iron and carbon steel metal parts are often not sufficient for the replacement of stainless steel parts. For this reason, the present invention provides an anticorrosive coating that uses conventional market coatings, such as electrolytic zinc, zinc alloys and organometallics, but with the application of a nano composite sealant, that is, with silicon ceramic nanoparticles and micro and/or nano particle fillers of 316L stainless steel, in order to obtain a passivation layer with the characteristics of stainless steel in iron and carbon steel parts.

The stainless steel particles prevent the penetration of weather without wearing or removing the nano ceramic sealant, increasing the useful life of the coating and consequently of the coated part, since the stainless steel nano and micro particles do not react with the compounds of the nano ceramic sealant, but act as a barrier against weathering, increasing the resistance of the sealant and consequently of the base coating, making the service life of the part 50 to 100 times longer in the neutral salt spray test (salt spray according to ASTM B-117 standard).

Thus, the present invention reveals a composition of a coating and the respective process of application of said coating on metallic substrates, maintaining the use of electrolytic zinc or zinc alloys as the basis of the coating against corrosion.

The coating of this invention may also be provided with a base layer configured by an organometallic dispersion (zinc flakes) based on zinc and aluminium flakes in an aqueous base or organic solvents, containing binding elements, organic solvents or water, alcohols and ethers; or a base of zinc alloys (zinc/iron, zinc/nickel) applied electrolytically to a metal surface.

In cases of using organometallic coatings (zinc flakes) as a base, the surface of the parts must be pre-treated prior to coating. In this process, pickling with acids, such as sulfuric acid or hydrochloric acid, is not used, which can produce atomic hydrogen and penetrate the steel structure and make it brittle. In order to avoid pickling processes, other pre-treatment processes are required.

Typical cleaning processes are degreasing which removes grease, oil and dirt from the surface of the metal with an alkaline aqueous solution and then abrasive cleaning using blasting with micro steel balls, whereby the blasting is responsible for removing surface oxidation through the mechanical action of the micro steel balls, which are fired at the parts inside a chamber using a turbine. None of the pretreatment processes produce any hydrogen, so there is no danger of any hydrogen embrittlement of high-strength steels.

After pre-treatment, the base layer coating process is carried out using the following application techniques:
Spray: Coating is applied to the surface of the parts using a spray gun. This can be done manually or in a fully automated spraying facility (this process is used for larger or heavy parts). The pieces are packed in supports or hung on hangers or templates.
Dip-spin (immersion and centrifugation): The pieces are placed in a basket of a centrifuge. Coating is applied by immersion in a container filled with the coating and after immersion, the basket starts centrifugation in order to remove the excess coating material (this process is used for small high-volume parts, also called batch process).
Immersion-draining: By dipping the parts inside the coating material and pulling it out so that the set drains the excess coating, for example, into pipes. The parts must, however, have sufficient openings so that the material can run, otherwise the coating may have flaws such as coating build-ups and air bubbles.

The coating forms a uniform, liquid layer on the surface of the parts in order to develop the excellent properties of zinc flake coatings, but a curing process is required.

The nano composite top layer is an aqueous layer containing silicon oxide nanoparticles of up to 50 nanometers dispersed in water, stainless steel micro and/or nano particles steel with a particle size of 0.01 to 40 micrometers, as well as binding elements, alcohols and ethers. This top layer is applied evenly over the base layer to significantly increase corrosion resistance.

Thus, the nano composite sealant, i.e. the top layer, comprises the following components by weight:

### Colorless Version:

15% to 30% Colloidal Silica;
0.2% to 5% Stainless Steel;
up to 8% 2-Butoxyethanol;
up to 10% Methanol;
from 35% to 70% Water;

### Black Version:

0.2% and 5% Stainless Steel;
up to 8% 2-Butoxyethanol;
up to 10% Methanol;
from 40% to 70% Water;
up to 5% Black Dye
from 20% to 25% Tetraethylorthosilicate;

In a preferred embodiment of the invention, the top layer comprises the following components in percentage by weight:

### Colorless Version:

30% Colloidal Silica;
0.5% Stainless Steel;
8% 2-Butoxyethanol;
10% Methanol;
51.5% Water;

### Black Version:

0.5% Stainless Steel;
8% 2-Butoxyethanol;
10% Methanol;
51.5% Water;
5% Black Dye
25% Tetraethylorthosilicate;

In another embodiment of the invention, an oxidized polyethylene wax solution or aqueous PTFE emulsion is added to the composition of the top layer, or as an additional layer for adjustment of the friction coefficient. The amount of lubricant may vary depending on the desired friction coefficient value, taking care not to exceed 10% in weight so as not to impair the performance of the final product.

In this way, the upper layer promotes the sealing of the surface of the base layer, preventing or hindering the contact of the base layer with the atmosphere and, in this way, increasing the life of the covered metal part.

Thus, the coating comprises at least the two distinct types of layers: the base layer and the top layer, which provide metal parts with high resistance to corrosion. Both base and top layers are free of hazardous substances, such as lead.

For the purpose of defining the application of the base coating layer, the cathode is the electrode in which the metal reduction and deposition occurs—the object that will be covered, and the anode is the electrode in which oxidation occurs, which can be soluble—in this case the anode metal goes into solution—or insoluble.

In general, different metals can be used for the coating of a part. The zinc coating process is called zinc plating. Zinc plating is a surface treatment that provides great resistance to corrosion, whereby the protective layer is uniform and adherent.

The zinc plating time determines the thickness of the deposited layer. In the present invention, the thickness of the electrolytic zinc or zinc alloys layer is between 5 and 18 micrometers, and the following zinc plating variants (rotary or stationary bath) can be used:
Alkaline zinc plating without cyanide, rotary and still bath;
Acid zinc plating;
Zinc/Iron Zinc Plating;
Zinc Nickel Zinc Plating.

In the present invention, electrolytic zinc or zinc alloys of 5 to 18 micrometers can be used, with acid zinc up to 12 micrometers and alkaline zinc from 12 micrometers.

### Acid Zinc Plating

Zinc deposition processes from an acid solution were developed more than 200 years ago. The first processes were based on zinc sulfate. Even today, this type of process is used for applications where operation at high current densities is required, such as continuous lines of sheets or wires. In zinc processes that operate in rotary drums or dropouts, the suitable acidic processes are those that use chloride-based solutions.

The concentrations and operating conditions with three processes are described in Table-1.

TABLE 1
ZINC ACID BASE PROCESS

| | Ammonia | Potassium | Mixed |
|---|---|---|---|
| Zinc metal | 10 to 50 g/L | 20 to 50 g/L | 10 to 50 g/L |
| Ammonium Chloride | 110 to 180 g/L | 0 | 30 to 60 g/L |
| Potassium chloride | 0 | 180 to 360 g/L | 120 to 180 g/L |
| Boric acid | 0 | 22 to 40 g/L | 0 |
| pH | 5 to 6 | 4.5 to 5.5 | 5 to 6 |
| Temperature (° C.) | 10 to 40 | 18 to 45 | 10 to 50 |

The following are the considerations for the operating parameters of zinc metal and chloride.

Zinc is replaced in the bath by means of the use of high-purity zinc anode in balls, bars, or ingots. As the process has good anodic corrosion efficiency, it is very easy to maintain the zinc concentration in the bath with good control of the anodic area.

Bar anodes are hung from the anode bus with titanium hooks, but it is much more common to use anode baskets constructed of titanium.

Chloride is responsible for the conductivity of the solution and anodic corrosion. High concentrations of chloride lower the turbidity point of the solution. Higher chloride concentration, higher tendency to burn at high current density, higher anode dissolution.

During electrolysis there is an evolution of hydrogen, according to the reaction shown above. With this, the pH rises and must be corrected with hydrochloric acid.

Ammonium chloride, in addition to the other functions, also serves as a pH buffer. When ammonia is not used, it is necessary to use boric acid for this function. For the complete elimination of ammonium chloride, it was necessary to develop new additive systems to achieve the same results reached with ammonia.

The additives were composed of non-water-soluble organic products that required solvents to remain soluble in the bath. These components were poorly tolerant to temperature, with turbidity points of the solution below 50° C., starting decomposition at temperatures of 30° C., causing stains and mists in the deposit, in addition to increasing organic contamination in the bath.

### Alkaline Zinc Plating

Cyanide-free alkaline electrolytic zinc is an environmentally friendly process (completely cyanide-free) that significantly reduces the amount of contaminated effluent generated. This process is indicated for iron, steel or zamak materials.

The use of this process provides the following advantages: excellent penetration; layer uniformity; freedom from white corrosion in weld areas, clear and bright deposits; It can be applied in a still bath process (larger items) or automatic rotary (smaller items).

After the application of zinc, the process is completed with passivation, which must be chosen according to the application characteristics of the items.

TABLE 2
ZINC ALKALINE BASE PROCESS

| | Preferred Range | | Range | |
|---|---|---|---|---|
| Zinc Metal | 10 to 12 | g/L | 8 to 17 | g/L |
| Zinc Oxide | 12.5 to 15 | g/L | 10 to 21 | g/L |

(purity >99.8%)

| | | | | |
|---|---|---|---|---|
| Caustic Soda | 130 to 140 | g/L | 110 to 140 | g/L |
| Sodium Carbonate | 50 | g/L | <80 | g/L |
| Temperature | 26 to 30° | C. | 22 to 40° | C. |

| | |
|---|---|
| Current Cathodic | 0.5 to 6 A/dm² |
| Density | |
| Cathodic Efficiency | 50 to 75% |
| Deposited Layer | 0.2 micrometer/minute using 1 A/dm² |
| Agitation | Cathodic 3 to 5 m/minute |

(recommended)

In another embodiment of the invention, the base coating layer (2) is organometallic (zinc flakes). Non-electrolytic organometallic coatings are made of lamellar zinc, which provides good protection against corrosion. These coatings comprise a mixture of zinc and aluminum, which are bonded together by an inorganic matrix. There are three groups of organometallic coatings:
Containing Cr(VI) (hexavalent chromium): surface treatments containing Cr(VI) provide greater protection against corrosion with a thinner layer, but Cr(VI) is carcinogenic and poses a potential risk to the environment. New European decrees prohibit the use of surface treatments containing Cr(VI). These include end-of-life vehicles) and electrical and electronic equipment. For applications outside the automotive and electrical industries, these coatings are still valid.

This invention is not based on organometallic coatings (zinc flakes) containing Cr(VI);
Cr(VI) free-hexavalent chromium-free solvent-based coatings;
Cr(VI) free-hexavalent chromium-free water-based coatings;
Cr(VI) free coatings are more environmentally friendly than surface treatments that contain Cr(VI). No organometallic coating used in the automobile industry today contains this substance.

In one embodiment of the invention, the composition of the base layer is an organic solvent-based organometallic coating (zinc flakes) that comprises the following composition in percentage by weight:
from 20 to 60% zinc;
from 1 to 5% aluminum—from 10 to 20% of 2-Ethylhexanol;
from 5 to 10% naphtha (mineral oil), heavy hydrodesulfurized;
from 0 to 3% alcohol n-butyl 71-36-3 1;
1 to 3% Naptha solvent, petroleum, light aromatic;
1 to 3% stearic acid;
from 0 to 0.2% of Ethylbenzene;
from 0 to 0.2% standard solvent.

In another embodiment of the invention, the composition of the aqueous-based organometallic coating (zinc flakes) is configured by mixing compounds A, B and C which comprise the following composition in percentage by weight:

### Compound A

from 20 to 40% zinc;
from 2 to 10% aluminum
20 30% Dipropylene Glycol
1 to 2.5% nonionic surfactant
15 to 20% deionized water

### Compound B

Silane (A-187)
70 to 90% deionized water
0.1 to 0.2% boric acid
2 to 3% sodium silicate

### Compound C

0.2 to 2% hydroxyethylcellulose per kg of mixture of compounds A+B

Various manufacturers, such as car companies and their suppliers, have produced their own specifications and supply rules in order to define the requirements for these coating systems.

Organometallic coatings form what is known as cathodic protection: the less noble metal (zinc) sacrifices itself to protect the base metal (steel). In this way, the steel can be protected. The average coating thickness is between 5 and 12 micrometers, and it is possible to apply thicker layers.

Thus, the process of applying the coating of this invention comprises the following steps:
(a) the base layer is applied to the surface of a metal substrate;
b) The upper layer is applied after the base layer has cured, whereby the upper layer is applied in liquid state by immersion and centrifugation, spray or immersion and draining, undergoing curing.

Each of the layers must be applied one or more times to the surface of a metal part, whereby when the top layer is applied twice, the first layer should dry between 8° and 100° C. for 25 minutes, and the second layer should be cured at between 170° C. and 190° C. for 25 minutes.

Similarly, when more than twice the top layer is applied, only the last layer should be cured between 170° C. and 190° C. for 25 minutes, the bottom layers should be dried between 8° and 100° C.

In addition, a base layer with a thickness of 5 to 18 micrometers must be applied, and up to 12 micrometers the zinc deposition process is carried out by means of an acid solution and from 12 micrometers the zinc deposition process is carried out by means of an alkaline solution.

The top nanocomposite layer should comprise a thickness of 0.5 to 4 micrometers, depending on the number of layers that are applied.

The description which has been made so far of the object of the present invention is to be regarded only as a possible or possible embodiments, and any particular features introduced into it are to be understood only as something which has been written for ease of understanding. Thus, they should not be considered as limiting the invention, which is limited to the scope of the claims.

The examples that will be presented illustrate the scope of the invention proposed herein.

### EXAMPLES

Accelerated corrosion tests were performed in a neutral salt spray chamber following ASTM B-117 or ISO 9227 standards. For this, there was applied in one or more layers of the coating in isolated parts and in parts installed in aluminum profile.

FIG. 2 shows the result of the test in which a layer of white electrolytic zinc of 5 to 8 micrometers and two layers of the composite top layer were applied after 5,664 hours of salt spray. It is noted that the piece had a darker coppery color, which is expected due to the passivation of the 316L stainless steel powder, however there was no red corrosion of the base metal.

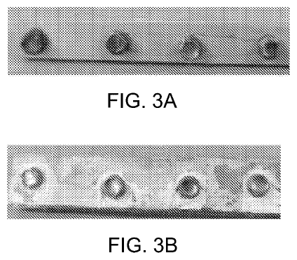

In FIG. 3a, it can be seen that the samples without application of the coating on 410 stainless steel after 936 h of salt spray showed red corrosion (red corrosion=corrosion of the iron/steel substrate) and, in FIG. 3b, it can be observed that with the application of the coating there was a significant decrease in the formation of red corrosion.

1. “Composition of a coating”, where the referred coating is configured by at least one base layer and at least one nano composite top layer, applied to the same metallic substrate, in which the base layer comprises:
an organometallic dispersion based on zinc and aluminium alloys, or
a base of zinc or zinc alloys applied electrolytically to the metal surface
characterized by the top nano composite layer comprising silicon oxide nanoparticles, stainless steel nano and micro particles and the following compounds in percentage by weight:
Colorless version:
15% to 30% Colloidal Silica;
0.2% to 5% Stainless Steel;
up to 8% 2-Butoxyethanol;
up to 10% Methanol;
from 35% to 70% Water; or
Black Version:
0.2% and 5% Stainless Steel;
up to 8% 2-Butoxyethanol;
up to 10% Methanol;
from 40% to 70% Water;
up to 5% Black Dye
from 20% to 25% of Tetraethylorthosilicate.

2. “Composition of a coating” according to claim 1, characterized by the aqueous top layer comprising silicon oxide nanoparticles, stainless steel micro and/or nano particles, and the following compounds as a percentage by weight:
Colorless version:
30% Colloidal Silica;
0.5% Stainless Steel;
8% 2-Butoxyethanol;
10% Methanol;
51.5% Water; or
Black Version:
0.5% Stainless Steel;
8% 2-Butoxyethanol;
10% Methanol;
51.5% Water;
5% black dye;
25% Tetraethylorthosilicate.

3. “Composition of a coating” according to claim 1, characterized by silicon oxide nanoparticles comprising a particle size of 0.1 to 50 nanometers.

4. “Composition of a coating” according to claim 1, characterised by the stainless steel micro and/or nano particles comprising a particle size of 0.01 to 40 micrometres.

5. “Composition of a coating” according to claim 1, characterized by the stainless steel being 316L.

6. “Composition of a coating” according to claim 1, characterized by the aqueous top layer further comprising 0 to 10% oxidized polyethylene wax or aqueous polytetrafluoroethylene emulsion.

7. “Application process” of a coating on a metal part that uses the composition of claim 1, characterized by comprising the following steps:
a) The base layer is applied to the surface of a metal part;
b) The top layer is applied after the base layer has cured, whereby the top layer is applied in the liquid state by immersion and centrifugation, spray or immersion and draining, curing in an oven with a temperature between 170° C. and 190° C. for 25 minutes.

8. “Application process” of a coating, according to claim 7, characterized by each of the layers being applied one or more times to the surface of a metal part.

9. “Application process” of a coating, according to claim 7, characterized by when applied twice to the top layer, the first layer should dry between 8° and 100° C. for 25 minutes, and the second layer should be cured between 170° C. and 190° C. for 25 minutes.

10. “Application process” of a coating, according to claim 7, characterized by when more than twice of the top layer is applied, only the last layer should be cured between 170° C. and 190° C. for 25 minutes, the bottom layers should be dried between 8° and 100° C.

11. “Application process” of coating (5) on a metal part, according to claim 7, characterized by a base layer with a thickness of 5 to 18 micrometers being applied, and up to 12 micrometers the zinc deposition process is carried out by means of an acid solution and from 12 micrometers the zinc deposition process is carried out by means of an alkaline solution.

12. “Application process” of a coating according to claim 7, characterized by applying a nanocomposite top layer with a thickness of 0.5 to 4 micrometers.
